(19) United States
(12) Patent Application Publication
(10) Pub. No.: US 2014/0197034 A1
(43) Pub. Date: Jul. 17, 2014

(54) Capacitive Conveyor-Belt Desalination

(71) Applicant: Israel Yaar, Sharon, MA (US)

(72) Inventor: Israel Yaar, Sharon, MA (US)

(21) Appl. No.: 14/151,881

(22) Filed: Jan. 10, 2014

Related U.S. Application Data
(60) Provisional application No. 61/752,499, filed on Jan. 15, 2013.

(51) Int. Cl. C02F 1/469

(52) U.S. Cl. CPC C02F 1/4691
USPC 204/668

(57) ABSTRACT

Described herein is a novel deionization process for seawater desalination: Seawater is contained in—or streams through—a semi-rectangular ionizing-chamber, two of its facing walls are wide electrostatic charged belts that continuously move through this chamber in a loop. The ions within the seawater separate under the force of the electrostatic field, the anions adhere to the anode belt and move with it, while the cations adhere to the cathode belt and move with it. These belts unload the adhered ions in a separate compartment from which the seawater, now at higher salt concentration, is discharged; consequently, the seawater left in the first compartment loses salt (ions) as the process continues, i.e., become desalinized.

### CROSS REFERENCE TO RELATED APPLICATION

This application is a U.S. non-provisional application that is based on—and claims priority to—U.S. Provisional Application No. 61/752,499 filed Jan. 15, 2013.

### BACKGROUND OF THE INVENTION

1. Field of Invention

This invention relates to water desalination, which may include the reduction of any ionic salt concentration in any solutions where salts are ionized, including but not restricted to seawater.

2. Description of Related Art

As of to date, there are several classes of water desalination techniques that have been researched and applied (Ref. 1-9):

(a) Distillation: Boiling seawater, collecting and condensing the water vapor into distilled water and discharging the high salt residue.
(b) Freezing seawater and separating the salt from the ice then heating the ice into fresh water.
(c) Reverse Osmosis (RO): Seawater is forced through membranes against osmotic pressure while filtering off the salts. Reverse osmosis is the most commonly used desalination technique nowadays.
(d) Electro-dialysis: Dissolved ionized salts are separated under electrostatic field by using multiple electrodialysis cells that are arranged into a configuration called an electrodialysis stack, with alternating anion and cation exchange membranes (Ref. 4).
(e) Capacitive deionization: this is “a technology for desalination and water treatment in which salts and minerals are removed from water by applying an electric field between two porous (often, carbon) electrodes, similar to electric double-layer capacitors. Counter-ions are stored in the electrical double layers which form at the solution interface inside the porous electrodes, with the ions of cations stored in the negatively charged electrode, and anions stored in the positively charged electrode (anode)” (Ref. 1, 5, 6, 7).

The latter is the closest technique to the proposed one but utilized completely different method in using the electrostatic field.

There are two different ways to desalinate seawater, either 1. Separate the water from the salt, or 2. Separate the salt from the water. Conceptually, in separating the water from seawater one applies energy to the water and is left with salt and fresh water in different compartments, while in separating the salt from the water one apply energy to the salt (or its ions) and is left with fresh water and salt in different compartments.

Even though ways 1. & 2. above seem to be identical as the results are the same, salt and fresh water end in different compartment, however, as the salt is in relative very small quantities within seawater the energy required is quite different between the two techniques; theoretically technique #1 will use much more energy than technique #2.

The hereby-proposed technique (this patent proposal) relates to technique #2; the desalination energy is used to move the salt (ions) out of the water.

To the best of my knowledge, after searching the literature and the US Patent Library, said proposed technique, even though relatively simple, is novel; it has not been suggested or utilized before.

Even though they are in active use at the present time, the drawback of classes (a) to (c) above are in the enormous energy used; The drawback of class (c), (d) and (e) is in the need for selective membranes that are expensive, easily contaminated and quite often in need of replacement. Even though class (e), “capacitive deionization” does not necessarily use semi-permeable membranes it utilize special porous (often, carbon) electrodes, which are expensive and deteriorate with time.

I expect the present patent proposal designs (see below) to use significantly less energy than any of the above-mentioned techniques; these proposed techniques do not use semi-permeable membranes and in some variations thereof do not use special porous electrodes either.

### REFERENCES

There are myriad of publications and patents related to water desalination, only a few of them I included here. After carefully screening the literature and the US Patent Library, I can attest that—to the best of my knowledge—none of them uses the designs of the present patent proposal.

1. http://en.wikipedia.org/wiki/Capacitive_deionization

### 2. Bataya A. Fellman: Carbon-Based Double Layer Capacitor for Water Desalination, Massachusetts Institute of Technology, 2010.

3. https://upload.wikimedia.org/wikipedia/en/c/c6/DoubleLayer.gif
4. http://www.rpi.edu/dept/chem-eng/Biotech-Environ/Environmental/desal/intro.html
5. P. M. Biesheuvel, B. van Limpt, and A. van der Wal: Dynamic Adsorption/Desorption Process Model for Capacitive Deionization J. Phys. Chem. C 2009, 113, 5636-5640
6. Christopher J. Gabelich, Tri D. Tran and I. H. “Mel” Suffet: Electrosorption of Inorganic Salts from Aqueous Solution Using Carbon Aerogels. Environmental Science & Technology, Vol. 36, No. 13, 2002

### 7. Capacitive Deionization of Seawater

Joseph C. Farmer, David V. Fix, Gregory V. Mack, John F. Poco, Jacquelyn K. Nielsen, Richard W. Pekala, Jeffery H. Richardson: This paper was prepared for submittal to 1995 Pacific Rim Environmental Conference in San Francisco, Calif. Oct. 2-4, 1995

8. Sandeep Sethi, Greg Wetterau: Seawater Desalination Overview. AWWA Manual M61, 2011.

9. Martin Z. Bazant, Mustafa Sabri Kilic, Brian D Storey adn Armand Ajdari: Nonlinear electrokinetics at large voltages. New Journal of Physics 11 (2009) 075016 (9 pp).

### Design #1: Desalination Using “Simple” Belts

Mechanism: The desalination unit (FIG. 1) is made of two rigid, elongated and comma-shaped non-conductors in its center—to be called the ‘Y’. This structure is firmly bolted and hermetically glued to the rigid container (encasement) on both sides. A thin, broad belt wraps each of the comma-shaped elements. Four elongated pulleys (shown here in cross section) drive the belts. The two belts come very close together in-between the two comma-shaped structures leaving an elongated and very narrow slit. A wide elongated cathode and a wide elongated anode rest on the upper surfaces of the-comma shaped structures; they are charged to a certain DC voltage. One belt slides over the anode and the other over the cathode. The design as shown in the two figures is out of scale, and the angle between the two arms of the ‘Y’ structure is exceedingly out of scale wide, in order to present the functionality of the various parts as depicted on the left side of the figures. Seawater is contained in the “V” shaped space that, from this point on, will be called the Deionization Chamber.

In broad lines: The belts dip into the seawater while moving over the DC charged anode and cathode accordingly. This results in a shift in the distribution of the electrons and positive holes in the belts inducing an electrostatic field inside them and in the Deionization Chamber. The ions within the seawater will move due to the electrostatic field and deposit on the moving belts accordingly (ref. 2, 9) and in part move with them. The DC charged anode and cathode end at the “knees” of the comma-shaped structures where these electrodes are replaced by non-conducting uncharged material (e.g. Plexiglas). At this level and below i.e., inside the elongated slit between the belts (FIG. 1 only *), the external electrical field does not exist. Therefore, the cations and the anions are not held by any external fields and can diffuse freely under their own osmotic pressure and electric charge; the system at that point reverts to neutral seawater; However, this seawater will be much more concentrated than the seawater in the deionization chamber, while the latter loses salt and rendered desalinated. The functions of the four elongated pulleys are to drive the belt, to squeeze highly concentrated salt solution into the discharge slit and prevent it from adhering to the belts and re-entering the deionization chamber.
In order to minimize the number of the figures, FIG. 1 shows a system without a discharging unit at the beginning (top) of the slit compartment within the ‘Y’, and FIG. 2 shows a system with a discharging unit there. Nonetheless, each design can be equipped or not equipped with a discharging unit at that location; see below.

From the above broad lines into specifics: In addition to the above, Design #1 can also be varied as follows:

1. Are the anode and the cathode insulated?
a. Not insulated
b. Insulated
2. What are the belts made of?
a. Conductive material (e.g. metallic, carbon cloth, etc.)
b. Non-conducting material (e.g. Teflon), or conductive material that is insulated.

Each of the above combinations deserves specific analysis as follows:

Combination design 1a2a: Non-insulated electrodes and non-insulated conductive belts. As these belts slide over non-insulated electrodes that are charged to a certain DC voltage they will themselves be charged to approximately the same voltage and will be capable to conduct electric current from the electrode to the seawater. This design will function well as long as the voltage is kept below about 1.5 Volts; above this voltage, electrolysis of the seawater will ensue. This design is akin to the present-day systems of ionization/desalination techniques. It has the advantage that in the technique presented here the walls of the deionizing chamber are moving, carrying the ions with them in a continuous motion into a continuous discharging process without the need for de-charging periods, while most other deionization techniques depend on pulse discharges.

Combination design 1a2b: Non-insulated electrodes and non-conductive belts. This design may function similar to 1a2a, as even though the belts are made of non-conducting material and will not freely conduct electricity from the electrodes to the belt-to-seawater interface; the electrodes will induce differential potential on the belt (FIG. 1) resulting in a comparable electrostatic field inside the deionization chamber. This design will probably be also limited to about 1.5 Volts on the electrodes as in practicality voltages above that might cause electrolysis emanating from the edges the bare electrodes where the belts are not expected to completely block the electrode-water interface.

The choice between designs 1a2a and 1a2b will be based on the available materials and their properties.

Combination design 1b2a and 1b2b: Insulated electrodes with conductive belts or insulated electrodes with non-conductive belts. In these designs the electrodes can be charged to high DC Voltages up to the breaking point of the insulation material (several hundred Volts) inducing a high static electric charge on the belts and as a consequence induce an electrostatic field in that chamber, bringing about ions to deposit on the belts. It is expected that under this high electrostatic field, ions will displace more water molecules from the surface of the belts than at the low voltages limits (approximately 1.5 Volts) of the present deionization techniques, and the 1a2a and 1a2b combination designs above. NOTE: An important cause for the present used deionization techniques inefficiency is the fact that a major part of the energy loss in these techniques is due to the adherence of water molecules onto the electrodes, or in our design to the belts. These water molecules take the space of salt ions; only electrostatic attracting and then releasing of salt ions contribute to desalination.

FIG. 1 presents Design #1 without electrical discharge points—see FIG. 2 below—however, this design should be functional with or without this electrical discharge points. These electrical discharge points may help conserve energy by discharging the electrostatic charged belts into external capacitors to be used somewhere else.

### Design #2: Desalination of Using “Complex” Belts

The basic built and function of design #2 is identical to design #1 but for the belts. The belts are complex and made of three layers each: A continuous, thin dielectric conveyor belt, on which conductive commutator plates are glued and on the latter conductive plates made of conductive porous material (polymeric foam, carbon cloth etc.) are attached.

As the belts dip into the seawater in the deionization chamber, the commutator plates connect to the charging electrodes, get charged and conduct this voltage to the porous plates. This will build an electrostatic field in the deionization chamber, which will cause ions to move and attach to and within the porous plates.

Each plate, once it glides over the knee within the ‘Y’, will be disconnected from its voltage source and face the opposing polarity plate placed very close-by within the slit.

Therefore, as stated above for Design #1, at this point the external electrical field does not exist anymore. Consequently, the cations and the anions are not held by any external electrical field and can diffuse freely (under their own osmotic and electrical forces). The system at this point reverts to neutral seawater. However, this seawater will be much more concentrated than the seawater in the deionization chamber as the latter loses salt and rendered desalinated.

FIG. 2 presents Design #2 with electrical discharge points, however, this design should be functional with or without this electrical discharge points. These electrical discharge points may help conserve energy by discharging the electrostatic charged belts into external capacitors to be used somewhere else.

The functions of the four elongated pulleys are the same as in Design #1.

As Design #2 utilizes belts that carry non-insulated live charge, it is limited to voltages below 1.5 Volts; higher voltages will cause electrolysis.

### Notes Applicable to the Two Basic Designs

FIG. 1 and FIG. 2 show that the devices discharge the high concentration salt-water downwards. This implies that at least in part the discharge will be under water pressure, pressure that might depend on the height of the slit within the ‘Y’ structure. This may interfere with the appropriate desalination speed. There are several remedies to this problem: Corrugated belts that interlace, or touch each other, limiting the discharge to the pace of theses belts; applying the appropriate air pressure from below or vacuum from above, or rotating the ‘Y’ structure to the appropriate angle; this structure can be rotated 180° degrees and still be functional.

Once porous conducting materials that can be insulated from within, covering the surfaces within all the pores, will be developed the approach of Design #1 will be possible to be applied to Design #2 as well.

Obviously, no experimental data is included in this patent proposal, as these designs have not been implemented in devices capable of producing such data. These designs are based on simple physics principles. Once this proposal is accepted, I expect these designs to be built and tested.

### DRAWINGS

FIG. 1 shows the schematics of Design #1 (cross-sections): The main features are explained in the figure itself and in the text. This figure contains two drawings, the right side is a picture of the cross-section of the proposed device; the left side shows expanded views of the electrodes, the belts, the electrostatic charging circuit and the charged particles. Positive ions in the water and positive charges on the electrodes and the belts are marked with plus signs (+). Negative ions in the water and negative charges on the electrodes and the belts are marked with minus signs (−). Water molecules are bipolar and are shown as open triangles, the vertex—the negatively charged oxygen atom—is shown as a relatively large dot, while the two positively charged hydrogen atoms are shown as two smaller dots. Some of the positive and some of the negative ions in the water attract several water molecules and are shown as the ion's charge within a circle with water molecules around it. The electrodes (the anode and the cathode) and the belts in this depiction of Design #1 are insulated (thick lines around each of them); however, in some rendering of this design that is not the case.

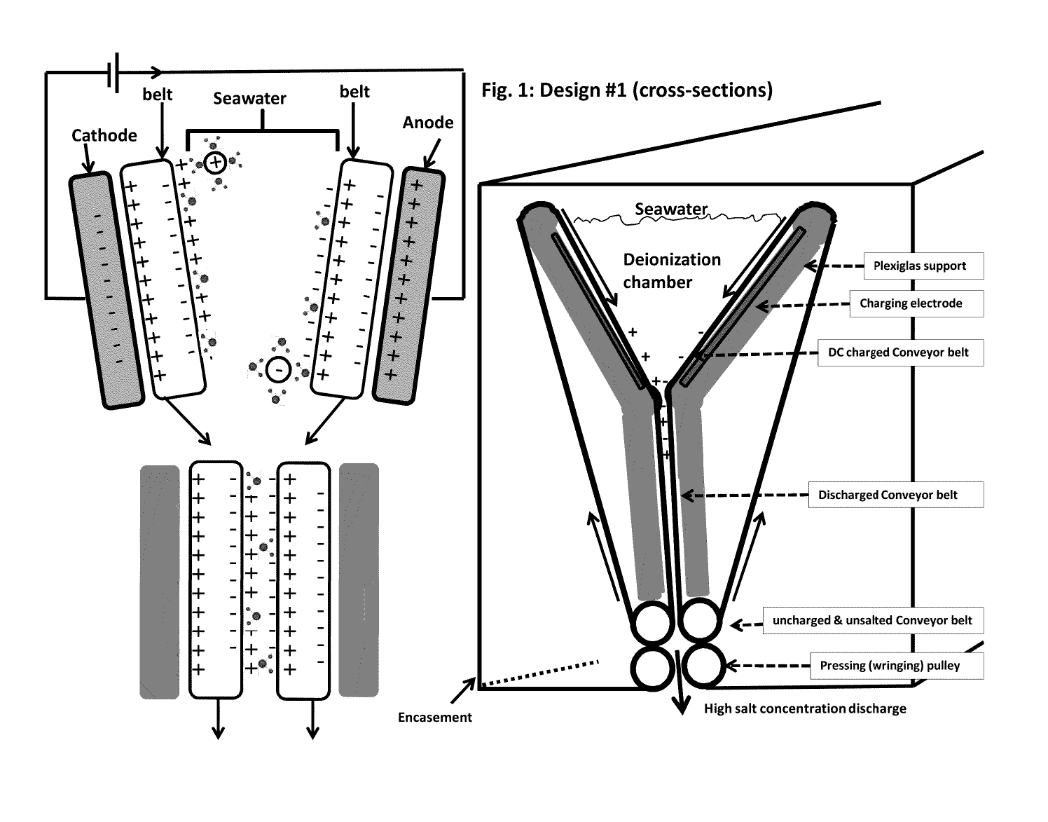

FIG. 2 shows the schematics of Design #2 (cross-sections): The main features are explained in the figure itself and in the text. This figure contains two drawings, the right side is a picture of the cross-section of the proposed device which is quite similar to the features of Design #1; the left side shows expanded views of the “complex” belts.

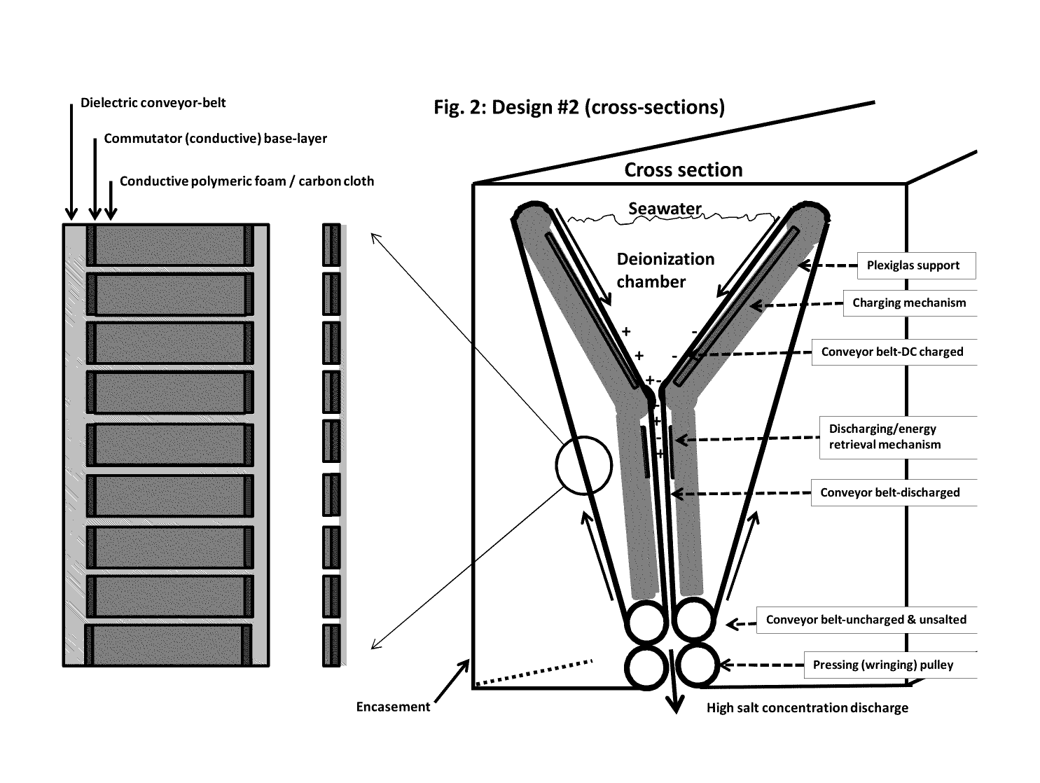

1. Capacitive conveyor-belt desalination designs as shown in the attached two figures and discussed in the text above.

2. In claim 1 the design includes a central structure (in this rendition a ‘Y’ shaped structure) that carries electrodes on it and encircled by belts. This claim is not restricted to a ‘Y’ shape, the same functionality can be attained with varied geometries.

3. In claim 1 the design includes belts made of—but not restricted to—metal, Teflon, carbon cloth or polymeric foam.

4. In claim 1 the belts are not restricted to smooth or corrugated, also, the ‘complex’ belts may be made in a varied way and still be compatible and included in this design.

5. In claim 1 the discharge mechanism is shown as four wringing pulleys but is not limited to them; any mechanism that will direct the salt-water discharge and/or prevent salt from re-circulating into the seawater will do.

6. In claim 1 the design is shown to discharge the salt-water downward, but in not restricted to that; the same design can discharge the salt-water in almost any angle with some necessary adaptations.

7. The electric discharge mechanism can be used in both designs can be shaped in many ways and function well; in these two designs the discharge mechanism is referred to in general way but is not restricted to this generality.

8. The ionizing electrodes were shown here as straight plates and in a very general way, but they are not limited and should include any type, material or geometry.

9. The encasement was shown here in general as cubic volume, but any structure will do.
